(19) United States
(12) Patent Application Publication
(10) Pub. No.: US 2016/0214333 A1
(43) Pub. Date: Jul. 28, 2016

(54) Method for Producing a Reinforced Fiber Composite Component

(71) Applicant: Bayerische Motoren Werke Aktiengesellschaft, Muenchen (DE)

(72) Inventors: Thomas SCHNAUFER, Oberhausen (DE); Andreas BEIL, Muenchen (DE); Simon SPITZER, Muenchen (DE)

(21) Appl. No.: 15/092,800

(22) Filed: Apr. 7, 2016

Related U.S. Application Data
(63) Continuation of application No. PCT/EP2014/071604, filed on Oct. 9, 2014.

(30) Foreign Application Priority Data
Oct. 18, 2013 (DE) 10 2013 221 172.4

(51) Int. Cl. B29C 70/48; B29C 70/68; B29C 44/32

(52) U.S. Cl. CPC B29C 70/48; B29C 44/32; B29C 70/68; B29K 2105/10

(57) ABSTRACT

A method is provided for producing a reinforced fiber composite component. The method includes the following acts: providing a reinforcing profile, enclosing the reinforcing profile with a core element, producing a sheath for the core element by braiding it with endless fibers, and impregnating the braided core element with a matrix. A reinforced fiber composite component provided in this manner includes a core element which is braided with a sheath, the core element enclosing a reinforcing profile that is arranged inside the core element.

### CROSS REFERENCE TO RELATED APPLICATIONS

This application is a continuation of PCT International Application No. PCT/EP2014/071604, filed Oct. 9, 2014, which claims priority under 35 U.S.C. §119 from German Patent Application No. 10 2013 221 172.4, filed Oct. 18, 2013, the entire disclosures of which are herein expressly incorporated by reference.

### BACKGROUND AND SUMMARY OF THE INVENTION

The invention relates to a method for producing a reinforced fiber composite component and to a reinforced fiber composite component.

The use of fiber composite components in motor vehicles is on the rise because they have high rigidity, yet also a low weight, compared to corresponding components made entirely of metal.

To achieve particularly high dimensional stability and a very low weight at the same time, fiber composite components are known which include a supporting core that is sheathed with a fiber structure made of carbon fibers or glass fibers by way of wrapping or braiding. In this way, a hollow profile-shaped fiber structure is provided, the dimensional stability of which is supported, and thereby strengthened, by the supporting core arranged within the created hollow profile. Among other things, supporting cores made of foamed plastic, wax, wood or metal are used.

However, due to the supporting fiber structure made of carbon fibers and/or glass fibers, such components do not have ductile material properties or have a low elongation at fracture. During a deformation of the component, this results in low structural integrity. Therefore, in the case of high degrees of deformation, there is the risk that the fiber structure will tear, and consequently the entire fiber composite component will break.

A possible method for producing a fiber composite semi-finished product is known from DE 10 2004 017 311 A1, for example, in which braiding threads are braided around a braided core.

It is the object of the invention to provide a particularly stable and fracture-proof fiber composite component, which at the same time has as low a weight as possible.

This and other objects are achieved by a method for producing a reinforced fiber composite component, as well as the fiber composite component itself, in accordance with embodiments of the invention.

According to the invention, a method for producing a reinforced fiber composite component is provided, comprising the following acts:

a. providing a reinforcement profile;

b. surrounding the reinforcement profile with a core element;

c. providing a sheath around the core element by braiding continuous filaments around the same; and

d. impregnating the braid-covered core element using a matrix.

Therefore, initially a reinforcement profile is provided, and the same is surrounded with a core element. This means that the core element is applied to an outer surface of the reinforcement profile, for example, and therefore surrounds the reinforcement profile at least in a circumferential direction of the reinforcement profile.

In this way, it is achieved that the core element is reinforced by the reinforcement profile and, depending on the material selection, a change in the material properties of the entire fiber composite component is effectuated, whereby the component is prevented from fracturing under high stresses.

For example, the reinforcement profile may comprise a rod-shaped or tubular profile made of plastic, metal and/or fiber-reinforced material, in particular fiber-reinforced plastic or fiber-reinforced metal.

In principle, the profile can have any arbitrary cross-sectional shape that is extended in a longitudinal direction of the profile. The simplest example is a circular cross-section, which is extended to form a hollow cylinder or in a tubular manner in the longitudinal direction. It goes without saying that other cross-sectional shapes can likewise be selected, in particular ovals or polygonal cross-sections can be used. In any case, the reinforcement profile can be designed as a hollow profile (tubular, for example) or as a solid profile made of solid material (rod-shaped, for example).

The composition of the fiber composite component makes it possible to design the cross-section of the reinforcement profile independently of a geometry of the sheath or of the outer contour of the fiber composite component. For example, the cross-section of the reinforcement profile can be designed in a weight-, load- and/or force-optimized manner. It is also possible to design the cross-sectional shape to be constant or variable along a longitudinal extension of the reinforcement profile. While the core element can be applied to the outer surface of the reinforcement profile and follow the outer contour of the same, an outer surface or contour of the core element may also have a cross-sectional shape that differs from that of the reinforcement profile. This shape can be based on a contour of the entire fiber composite component, for example, so that the desired component contour is provided after the sheath is produced or after impregnation. In other words, the core element therefore bridges a potential sudden geometric change or geometric difference between the reinforcement part and the sheath or the component contour. An exemplary embodiment is shown in FIG. 2.

The step of impregnating can, in particular, include an impregnating by way of the resin transfer molding method (RTM for short). It is likewise possible to carry out the step of impregnating by way of other known impregnating methods. Suitable impregnating methods are already generally known, so that a detailed description of the same may be dispensed with.

In contrast, the sheath can include, for example, continuous filaments made of glass fibers, aramid fibers and/or carbon fibers. The sheath shall be understood to mean a fiber structure that is produced, in particular, by way of braiding and is impregnated using a matrix. To this end, the materials of the continuous filaments can be arbitrarily combined with different materials of the core element.

For the selection of the core element, suitable connectability not only to the reinforcement profile, but also to the sheath is decisive. Moreover, the core element should preferably have sufficient pressure stability, for example so as to withstand an injection of matrix during the step of impregnating.

For this purpose, the core element can be designed as a plastic element, a wooden element, or as a foam element made of foamed metal or plastic, for example. For example, it is possible to produce the plastic element by way of known injection molding methods. Optionally, additionally a reinforcement of the plastic element using fibers, such as carbon fibers, glass fibers or aramid fibers, is possible. Likewise, the plastic element can be designed as a sheet molding compound (SMC) or the like.

Plastic materials or resins in particular are suitable as the matrix, which are introduced at least into the fiber structure of the sheath by the step of impregnating, or additionally—to the extent this is possible—are introduced into the core element, and cured. In this way, at least the impregnated sheath is formed of fiber-reinforced plastic or fiber-reinforcedesin.

According to further embodiments, the step of surrounding the reinforcement profile can include a covering in foam or insert molding so as to generate the surrounding core element. For this purpose, the reinforcement profile can be placed into a corresponding foaming mold or injection mold.

Furthermore, a reinforced fiber composite component having a core element is proposed, around which a sheath is braided, wherein the core element surrounds a reinforcement profile arranged within the core element.

The fiber composite component is preferably produced by way of a method according to the invention.

According to one embodiment, the fiber composite component is a fiber-reinforced structural body component or a reinforcement component of a motor vehicle. The structural body component can be a pillar, for example, in particular an A, B, C or D pillar, a cross-rail, sill, an engine mount, a longitudinal beam, transverse beam, side frame or the like. Likewise, the fiber composite component can be designed as a reinforcement component which can be connected to a structural body component, such as a body pillar reinforcement, in particular an A, B, C or D pillar reinforcement, which is inserted between an outer and an inner side frame.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a side view of a reinforced fiber composite component according to an embodiment of the invention; and

FIG. 2 is a cross-section of the reinforced fiber composite component of FIG. 1.

### DETAILED DESCRIPTION OF THE DRAWINGS

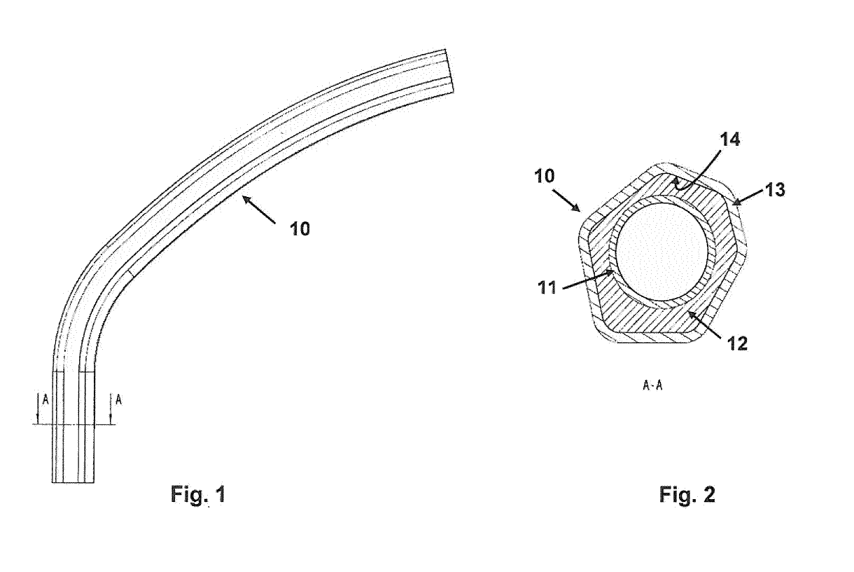

FIG. 1 shows a reinforced fiber composite component, which in the shown embodiment is configured, by way of example, as a reinforcement component for an A pillar of a motor vehicle. This component can be inserted between an outer and an inner side frame or shell of the vehicle.

FIG. 2 shows a cross-section A-A of the fiber composite component 10 illustrated in FIG. 1, having a core element 12 around which a sheath 13 is braided on an outer surface 14 of the core element 12. Moreover, the core element 12 surrounds a reinforcement profile 11 arranged within the core element 12.

Due to the reinforcement profile 11, which is integrated into the fiber composite component 10 and is arranged or enclosed within the core element 12, the component properties of the entire fiber composite component 10 are influenced, and its strength is increased. For example, it is possible to provide the reinforcement profile 11 as a tubular profile made of metal or plastic or a fiber-reinforced material, and thereby increase strength, and to promote an additional ductile property of the fiber composite component 10. This prevents the fiber composite component 10 from tearing completely, even when being subjected to large deformation paths.

In the shown embodiment, the reinforcement profile 11 is designed as a hollow profile, which makes high rigidity and a low weight possible at the same time.

The reinforced fiber composite component 10 can be produced, for example, by way of a method in which initially the reinforcement profile 11 is provided and placed, for example, into a foaming mold or an injection mold (neither one is shown). There, the reinforcement profile 11 is covered with a foam material, or insert molded, for producing the core element 12, so that the core element 12 surrounds the reinforcement profile 11. Suitable materials for the core element 12 are, for example, plastic, wood, or foamed material made of plastic or metal.

Subsequently, the core element 12 having the integrated reinforcement profile 11 is removed from the foaming mold and surrounded with a sheath 13 by braiding continuous filaments around the same. The braid-covered core element 12 created in this way (including the integrated reinforcement element 11) can subsequently be impregnated, for example, using a matrix by way of the resin transfer molding method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a reinforced fiber composite component, the method comprising the acts of:
providing a reinforcement profile;
surrounding the reinforcement profile with a core element;
producing a sheath around the core element by braiding continuous filaments around the core element to obtain a braid-covered core element; and
impregnating the braid-covered core element using a matrix.

2. The method according to claim 1, wherein the reinforcement profile comprises a rod-shaped profile made of plastic, metal and/or fiber-reinforced material.

3. The method according to claim 2, wherein the sheath comprises continuous filaments made of glass fibers, aramid fibers and/or carbon fibers.

4. The method according to claim 1, wherein the sheath comprises continuous filaments made of glass fibers, aramid fibers and/or carbon fibers.

5. The method according to claim 1, wherein the core element is designed as a plastic element, as a wooden element, or as a foam element made of foamed metal or plastic.

6. The method according to claim 1, wherein the act of surrounding the reinforcement profile comprises covering the reinforcement profile in foam or insert molding of the reinforcement profile so as to produce a surrounded core element.

7. The method according to claim 5, wherein the act of impregnating comprises impregnating by way of a resin transfer molding process.

8. The method according to claim 1, wherein the act of impregnating comprises impregnating by way of a resin transfer molding process.

9. A reinforced fiber composite component produced according to the method of claim 1.

10. A reinforced fiber composite component, comprising:
a reinforcement profile;
a core element that surrounds the reinforcement profile;
a braided sheath around the core element.

11. The reinforced fiber composite component according to claim 10, wherein the braided sheath is impregnated using a matrix.

12. The reinforced fiber composite component according to claim 10, wherein the reinforced fiber composite component is a structural body component or a reinforcement component of a motor vehicle.
